(19) United States
(12) Patent Application Publication
(10) Pub. No.: US 2008/0129202 A1
(43) Pub. Date: Jun. 5, 2008

(54) DOSE COMPOSITION SUITABLE FOR HOLLOW PLUG CERAMIC METAL HALIDE LAMP

(76) Inventors: Raghu Ramaiah, Euclid, OH (US); Joshua I. Rintamaki, Westlake, OH (US); Dennis S. Bradley, Twinsburg, OH (US)

Correspondence Address: FAY SHARPE LLP, 1100 SUPERIOR AVENUE, SEVENTH FLOOR, CLEVELAND, OH, 44114, US

(21) Appl. No.: 12/032,715

(22) Filed: Feb. 18, 2008

Related U.S. Application Data
(63) Continuation-in-part of application No. 11/040,990, filed on Jan. 21, 2005.

(51) Int. Cl. H01J 17/20; H01J 9/00

(52) U.S. Cl. 313/640; 445/23

(57) ABSTRACT

A lamp includes a discharge vessel with electrodes extending into the discharge vessel and an ionizable fill sealed within the vessel. The fill includes a buffer gas, optionally mercury, and a halide component comprising a sodium halide, a lanthanum halide, a thallium halide, and a calcium halide.

This application claims the priority, as a continuation-in part, of U.S. application Ser. No. 11/040,990, filed Jan. 21, 2005, entitled “Ceramic Metal Halide Lamp,” the disclosure of which is incorporated herein by reference in its entirety.

### BACKGROUND OF THE INVENTION

The present invention relates generally to ceramic arc discharge lamps and more particularly to a discharge lamp with an end zone having reduced wall thickness and a dose comprising sodium, thallium, calcium, and lanthanum, generally in the form of their halides.

Discharge lamps produce light by ionizing a fill material, such as a mixture of metal halide and mercury in an inert gas, such as argon, with an arc passing between two electrodes. The electrodes and the fill material are sealed within a translucent or transparent discharge chamber, which maintains the pressure of the energized fill material and allows the emitted light to pass through. The fill material, also known as a “dose,” emits a desired spectral energy distribution in response to being vaporized and excited by the electric arc. For example, halides provide spectral energy distributions that offer a broad choice of light properties, including color temperatures, color rendering, and luminous efficiency.

Conventionally, the discharge chamber in a discharge lamp was formed from a vitreous material such as fused quartz, which was shaped into desired chamber geometries after being heated to a softened state. Fused quartz, however, has certain disadvantages, which arise from its reactive properties at high operating temperatures. For example, in a quartz lamp, at temperatures greater than about 950-1000° C., the halide filling reacts with the glass to produce silicates and silicon halide, which results in depletion of the fill constituents. Elevated temperatures also cause sodium to permeate through the quartz wall, which causes depletion of the fill. Both depletions cause color shift over time, which reduces the useful lifetime of the lamp. Color rendition, as measured by the color rendering index (CRI or Ra) tends to be moderate in existing quartz metal halide (QMH) lamps, typically in the range of 65-70 CRI, with moderate lumen maintenance, typically 65-70%, and moderate to high efficacies of 100-150 lumens per watt (LPW). U.S. Pat. Nos. 3,786,297 and 3,798,487 disclose quartz lamps which use high concentrations of cerium iodide in the fill to achieve relatively high efficiencies of 130 LPW at the expense of the CRI. These lamps are limited in performance by the maximum wall temperature achievable in the quartz arctube.

Ceramic discharge chambers were developed to operate at higher temperatures for improved color temperatures, color renderings, and luminous efficacies, while significantly reducing reactions with the fill material. In general, CMH lamps are operated on an AC voltage supply source with a frequency of 50 or 60 Hz, if operated on an electromagnetic ballast, or higher if operated on an electronic ballast. The discharge is extinguished, and subsequently re-ignited in the lamp, upon each polarity change in the supply voltage.

One problem with such lamps is that the light output deviates from that of “white” light. One way to measure this is as the difference in chromaticity of the lamp's color point, on the y axis (ccy) from that of the standard black body curve plotted on a CIE (Commission Internationale de I'Eclairage) 1931 chromaticity diagram in which the chromaticity coordinates represent relative strengths of two of the three primary colors, denoted by x and y. This chromaticity difference is referred to herein as Dccy. The black body curve (or Planckian locus) represents the color points on the CIE chromaticity diagram traversed by an incandescent object as its temperature is raised and occupies the central white region. Two lamps whose x,y coordinates fall one above the black body curve and one below could have the same correlated color temperature (CCT) while having a different hue. For many applications, it is desirable to have light with virtually no hue, e.g., without a greenish or reddish tint.

The properties of high intensity discharge lamps operated at high temperatures tend to suffer. Ceramics operated at high temperature degrade in their mechanical strength, and consequently the lamps may not withstand the stresses on the ceramic that are present during lamp operation. This leads to premature lamp failure or poor reliability. CRI, lower CCT and Dccy close to the black body locus are often all desired, thus lamp lumen maintenance generally has to be sacrificed. In general, the higher the wall temperature, or wall loading, generally the poorer the lamp lumen maintenance, and poorer lamp reliability.

The exemplary embodiment provides a ceramic metal halide lamp capable of emitting light which is close to the black body curve, which overcomes the above-referenced problems and others.

### BRIEF DESCRIPTION OF THE INVENTION

In accordance with one aspect of the exemplary embodiment, a lamp includes a discharge vessel. Electrodes extend into the discharge vessel. An ionizable fill is sealed within the vessel. The fill includes a buffer gas, optionally mercury, and a halide component. The halide component includes a sodium halide, a lanthanum halide, a thallium halide, and a calcium halide.

In accordance with another aspect of the exemplary embodiment, a method of forming a lamp includes providing a discharge vessel, providing electrodes which extend into the discharge vessel, and sealing an ionizable fill within the vessel. The fill includes a buffer gas, optionally mercury, and a halide component comprising a sodium halide, a lanthanum halide, a thallium halide, and a calcium halide.

In accordance with another aspect of the exemplary embodiment, a lamp includes a discharge vessel. Electrodes extend into the discharge vessel. An ionizable fill is sealed within the vessel. The fill includes a buffer gas, optionally mercury, and a halide component. The halide component consists essentially of a sodium halide, a lanthanum halide, a thallium halide, and a calcium halide.

### BRIEF DESCRIPTION OF THE DRAWINGS

FIG. 1 is a cross sectional view of a lamp in accordance with the exemplary embodiment;

FIG. 2 is an enlarged cross sectional view of the discharge vessel of FIG. 1;

FIG. 3 is an enlarged exploded cross-sectional view of the discharge vessel of FIG. 1;

FIG. 4 is a plot of maximum wall temperature vs. lamp wall loading for a conventional CMH lamp;

FIG. 5 is a plot of lumen maintenance vs. lamp wall loading for a conventional CMH lamp;

FIG. 6 is a plot of CRI vs. lamp wall loading for a conventional CMH lamp;

FIG. 7 is a plot of CCT vs. lamp wall loading for a conventional CMH lamp;

FIG. 8 is a plot of Dccy vs. lamp wall loading for a conventional CMH lamp;

FIG. 9 is a plot of lumens vs. lamp wall loading for a conventional CMH lamp;

FIG. 10 shows plots of lamp CCT vs TTP for La-lamps and Ce-lamps;

FIG. 11 shows plots of color rendition index (CRI) for the lamps of FIG. 10;

FIG. 12 shows plots of the correlated color temperature (CCT) for the La and Ce lamps at 100 hrs;

FIG. 13 shows comparisons of lamp lumen maintenance for lamps containing Na—Ce chemistry vs. lamps containing Na—La chemistry; and

FIG. 14 shows Dccy plots of various lamps as x,y cords of various rare earth halides, with respect to the black body locus, for inferring Dccy values.

### DETAILED DESCRIPTION OF THE INVENTION

Aspects of the exemplary embodiment relate to a lamp which includes a discharge vessel with an ionizable fill containing lanthanum sealed therein. The discharge vessel may include a generally cylindrical barrel and first and second end plugs formed of a ceramic material. The first and second end plugs each include an end wall and at least one tubular leg portion. The end plugs are hollow or have an end wall which is sufficiently thin that the end wall does not tend to perform as a heat sink.

In various aspects, the lamp is able to simultaneously satisfy photometric targets without compromising targeted reliability or lumen maintenance. Some of the photometric properties that are desirable in a lamp design include CRI, CCT, Lumens (e.g., expressed as Lumens/watt), and Dccy.

The color rendering index CRI is a measure of the ability of the human eye to distinguish colors by the light of the lamp. The color rendering index Ra, as used herein, is the standard measure used by the Commission Internationale de l'Eclairage (CIE) and refers to the average of the indices for eight standardized colors chosen to be of intermediate saturation and spread throughout a range of hues measured (sometimes referred to as R8). Values are expressed on a scale of 0-100, where 100 represents the value for a black body radiator. The exemplary lamp may have a color rendering index, Ra of at least 85, e.g., at least about 90 Ra, and can be up to about 96, or higher.

The correlated color temperature CCT, as used herein, is the color temperature of a black body radiator which in the perception of the human eye most closely matches the light from the lamp. The exemplary lamp may provide a correlated color temperature (CCT) between about 2800K and about 3200K, e.g., 3000K.

Lumens (lm), as used herein, refer to the SI unit of luminous flux, a measure of the perceived power of light. If a light source emits one candela of luminous intensity into a solid angle of one steradian, the total luminous flux emitted into that solid angle is one lumen. Put another way, an isotropic one-candela light source emits a total luminous flux of exactly 4π lumens. The lumen can be considered as a measure of the total “amount” of visible light emitted. The output of a lamp can be defined in terms of lumens per Watt (LPW).

In one embodiment the lumens per watt (LPW) of the exemplary lamp at 100 hours of operation is at least 90, and in one specific embodiment, at least about 100 or at about 110.

The exemplary lamp may have a Dccy of +/−0.005 with respect to the black body locus, and in one specific embodiment, the lamp lies directly on the black body locus, i.e. Dccy=00.

All of these ranges may be simultaneously satisfied in the present lamp design. Unexpectedly, this can be achieved without negatively impacting lamp reliability or lumen maintenance. Thus, for example, the exemplary lamp may have a lumen maintenance of approximately 95% or better at 2000 hours, e.g., at a wall temperature which is no greater than 1360K.

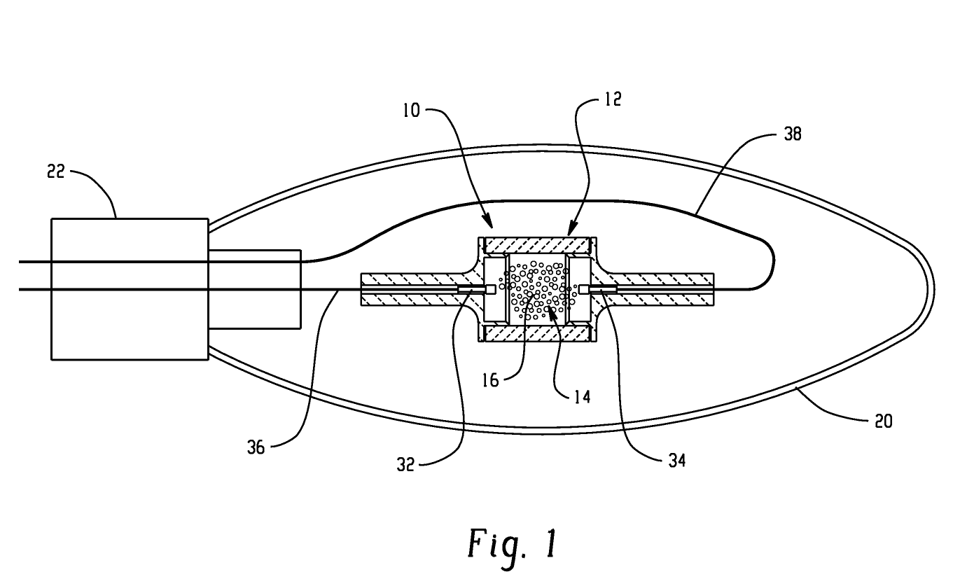

With reference to FIG. 1, a lamp assembly comprising a ceramic metal halide (CMH) discharge lamp 10 in accordance with the exemplary embodiment is shown. The lamp 10 includes a discharge vessel 12 in the form of a high pressure envelope or arctube, formed from a transparent or translucent material, such as polycrystalline alumina or sapphire (single crystal alumina), which is sealed at opposite ends to enclose a chamber or discharge space 14. The discharge vessel is suited to use in lamps operating at a variety of wattages, such as about 20-150 watts, although higher wattages are also contemplated. The lamp is supplied with current by a circuit (not shown) connected with a source of AC power. The lamp may be designed to run on an electronic ballast, at higher frequency. Alternatively, the lamp may be run on a DC power source.

The discharge space 14 contains a fill of an ionizable gas mixture 16 such as metal halide and inert gas mixture which may also include mercury. The discharge vessel is enclosed in an outer envelope 20 of glass or other suitable transparent or translucent material, which is closed by a lamp cap 22 at one end.

First and second internal electrodes 32, 34, which may be formed from tungsten, extend into the discharge space 14. A discharge forms in the fill 16 between the electrodes 32, 34 when a voltage is applied across the electrodes. As shown in FIG. 1, the main electrodes are connected to conductors 36, 38, formed from molybdenum and niobium sections. The connectors electrically connect the electrodes to the external power supply (via the cap 22). It will be appreciated that other known electrode materials may alternatively be used.

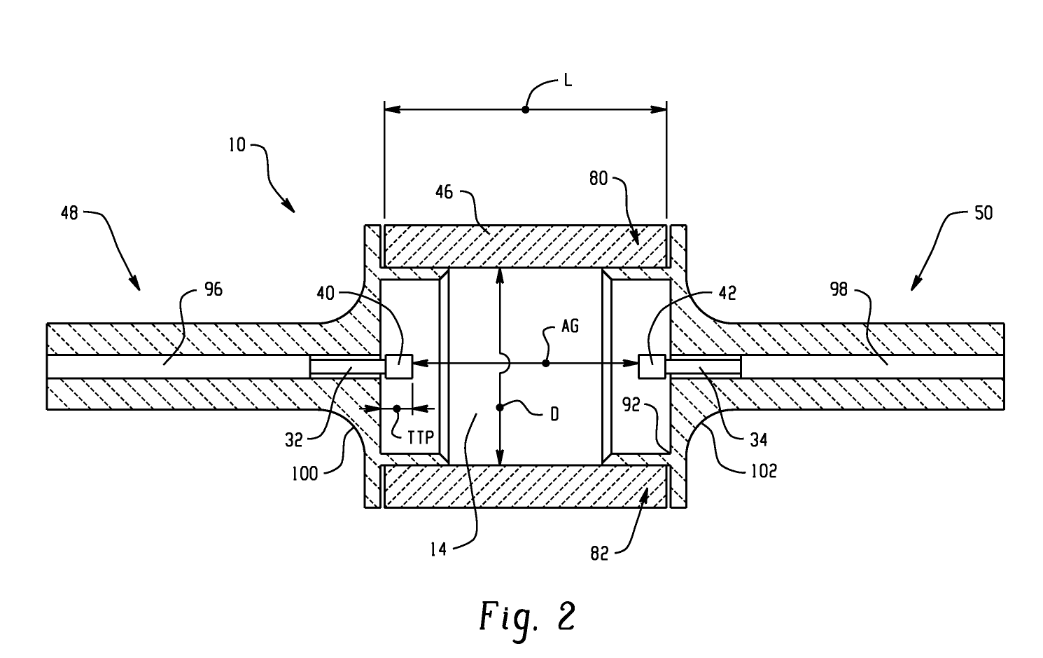

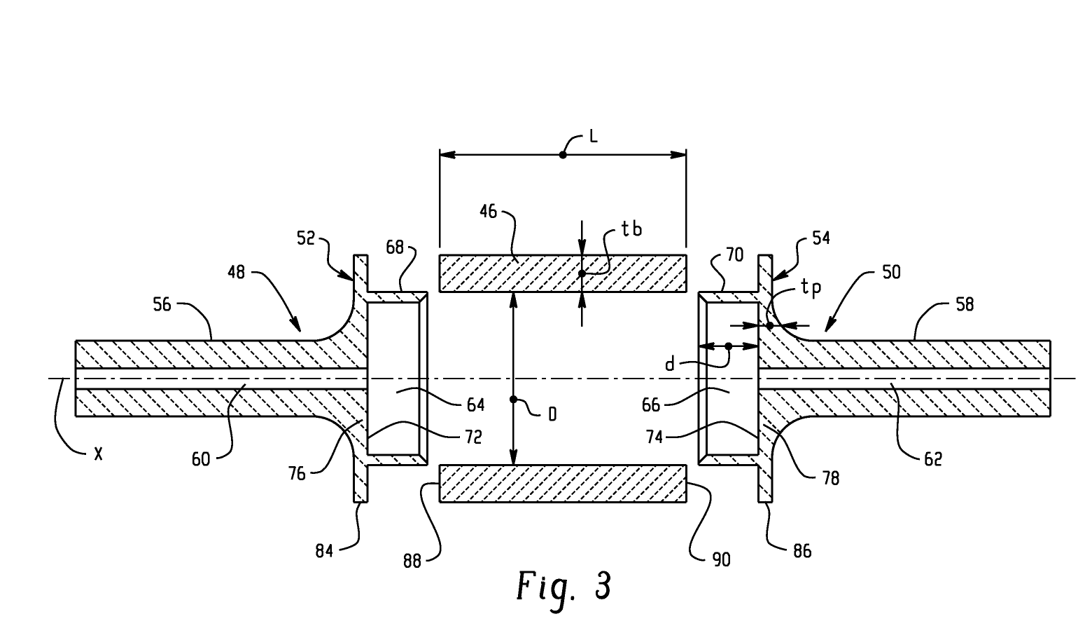

With reference now to FIGS. 2 and 3, tips 40, 42 of the electrodes 32, 34 are spaced by an arc gap AG.

The ceramic arctube 12 includes a hollow cylindrical portion or barrel 46 and two opposed hollow end plugs 48, 50. The barrel 46 and end plugs 48, 50 are formed from separate components (FIG. 3) that are fused together during formation of the lamp. The two end plugs may be similarly shaped and each include a cylindrical base portion 52, 54, from which respective hollow leg portions or tubes 56, 58 extend outwardly. The electrodes 32, 34 are seated in bores 60, 62 within their respective leg portions 56, 58 and extend into respective hollow portions 64, 66, of the cylindrical base portions. Each hollow portion 64, 66 is defined between a cylindrical wall or skirt 68, 70 of the base portion 52, 54 and an interior surface 72, 74 of a respective end wall 76, 78 of the base portion. The skirts 68, 70 are received in the respective ends of the barrel 46 to create an annular thickened region 80, 82 when the two parts are joined together (FIG. 2). The skirts extend in an annular ring adjacent the barrel. As shown in FIG. 3, the skirt 68, 70 is spaced inwardly from the peripheral edge of the respective end wall 76, 78 by an annular rim portion or flange 84, 86. The flange is seated on a corresponding annular end 88, 90 of the barrel 46 when the arctube 12 is assembled.

The end walls 76, 78 are provided with a thickness tp large enough to spread heat, but small enough to prevent or minimize light blockage. Discrete interior corners 92 provide a preferred location for halide condensation. The structure of the end wall 76, 78 enables a more favorable optimization, significantly one with a lower L/D. The following features, alone or in combination, have been found to assist in optimizing performance: 1) a smooth fillet transition between the exterior end and the leg so as to reduce stress concentrations, 2) an end thickness large enough to spread heat, but small enough to prevent light blockage and avoiding serving as a significant heat sink, and 3) discrete corners to provide a preferred location for halide condensation.

The discharge chamber 14 is sealed at the ends of the leg portions 56, 58 by seals 96, 98 (FIG. 2), to create a gas-tight discharge space.

In one embodiment, each of end plugs 48, 50 includes an annular curved portion or fillet 100, 102, which extends between the substantially uniform thickness leg portion 56, 58 and the end wall 76, 78, which gives ends of the leg portions a contoured appearance. This avoids sharp corners between the legs 56, 58 and the end walls 76, 78, which could otherwise contribute to fractures. The curved portions 100, 102 typically have a radius of curvature of about 1-3 millimeters. Alternatively, the leg portions may be tapered.

Various dimensions of the arctube will now be defined:

The ceramic wall thickness th is defined as the thickness (mm) of the wall material in the central portion of the arctube body, e.g., half way between the electrode tips. The tb may be, for example, about 1-2 mm, e.g., about 1.3-1.7 mm. In general, tb may be higher for higher wattage lamps

The plug thickness tp is the thickness of the end wall of the plug. Where the end wall is contoured, the minimum plug thickness tpmin is typically in the corner, where the skirt meets the end wall. In one embodiment, tpmin is greater than 0.6 mm.

The plug depth d is the interior dimension of the hollow portion of the plug. In general d>0.5*tpmin or ≧1*tpmin. In some embodiments, d>2*tpmin and in the illustrated embodiment, d>2.5*tpmin.

The arctube length L is the internal distance between the end walls (in mm). The XL as measured along the lamp axis X can be, for example, about 6-10 mm, e.g., about 8 mm. The arctube diameter D is the internal diameter of the arctube, measured in a region between the electrodes. The D can be, for example, about 5-7 mm. The aspect ratio (L/D) is defined as the internal arctube length divided by the internal arctube diameter and can be, for example, between about 0.85 and 1.5, for example, about 1.38.

The arc gap AG is the distance (mm) between the electrode tips 40, 42 at the closest point and can be, for example, about 3-8 mm, e.g., about 6 mm. The tip-to-plug distance (TTP) or tip protrusion is the distance (mm) from the electrode tip 40, 42 to the adjacent respective surface of the end wall of the plug defining the internal end of the arctube body. The arc gap is related to the internal arctube length L by the relationship AG+2TTP=L. Optimization of TTP leads to an end structure hot enough to provide the desired halide pressure, but not too hot to initiate corrosion of the ceramic material. In one embodiment, TTP is about 0.9-3.3 mm, for example, about 1.0-1.4 mm, e.g., about 1.3 mm.

As used herein, “Arctube Wall Loading” (WL) is the arctube power (watts) divided by the arctube surface area (square mm). For purposes of calculating WL, the surface area is the total external surface area including end bowls, but excluding legs, and the arctube power is the total arctube power including electrode power. WL can be ≦35 w/cm². In one embodiment, the wall loading is from about 27 to 34 w/cm², for example, about 30 w/cm². Such a wall loading can be achieved when the wall temperature is about 1360K maximum.

The dimensions of the exemplary lamp can thus be as shown in Table 1:

TABLE 1

| | | | | Exemplary | |
|---|---|---|---|---|---|
| Parameter | Abbreviation | Range | | Range | |
| Wall Thickness | Tb | 1-2 | mm | 1.3-1.7 | mm |
| Plug Thickness | Tp | 0.5-2 | mm | 0.6-0.8 | mm |
| Plug Depth | D | 0.3-1.5 | mm | 1.2-1.5 | mm |
| Inner Length | L | 6-10 | mm | 7.5-8.5 | mm |
| Inner Diameter | D | 5-7 | mm | 5.5-6.8 | mm |
| Arc Gap | AG | 3-8 | mm | 5.5-6.0 | mm |
| Tip-To-Plug | TTP | 0.9-3.3 | mm | 1-1.4 | mm |
| Wall Loading | WL | 27-34 | w/cm² | 29-32 | w/cm² |

The exemplary cylindrical portion 46 and end plugs 48, 50 are all formed from a polycrystalline aluminum oxide ceramic, although other polycrystalline ceramic materials capable of withstanding high wall temperatures up to 1700-1900° K and which are resistant to attack by the fill materials are also contemplated.

The exemplary fill 16 includes a metal halide component or “dose” which includes halides of sodium, thallium, calcium, and lanthanum, in addition to mercury and a rare gas, such as Argon or Xenon. The halides may be chlorides, bromides, or iodides. In one embodiment, sodium, thallium, calcium, and lanthanum are the only halides included in the fill. In particular, the lamp fill is free of all other rare earth halides, such as dysprosium, cerium, and the like. By “free,” it is meant that these rare earth halides, where present, represent, in total, no more than 1 mol % of the dose, and generally less than 0.5%. The halide component, in this embodiment, thus consists essentially of a sodium halide, a lanthanum halide, a thallium halide, and a calcium halide. In some embodiments, rare earth halides, other than mentioned above, are at a mole % of <0.01, or <0.001, i.e. as close to a mole % of 0% as can be practically achieved.

Mole fractions (moles of a dose component divided by total moles of the dose components) may be as follows, where X represents Cl, Br, or I:

NaX>0.5, e.g., 0.6-0.8, such as about 0.7

TIX>0.02, e.g., 0.03-0.06, such as about 0.04

CaX₂>0.09, e.g., 0.1-0.3, such as about 0.18

LaX₃>0.04, e.g., 0.05-0.01, such as about 0.07

In one embodiment, the mole fractions of the dose components are in the relationship NaI:TlI:CaI₂:LaI₃=0.71:0.04:0.18:0.07, where each value can vary by ±5% of its value, yet keeping the sum of mole fractions equal to 1.

The halide weight (HW), which is the weight (mg) of the halides in the arctube 12, can be from about 8-14 mg, and for the embodiment illustrated, a halide weight being 12 mg is employed. Different sized vessels for higher/lower wattages may employ different amounts.

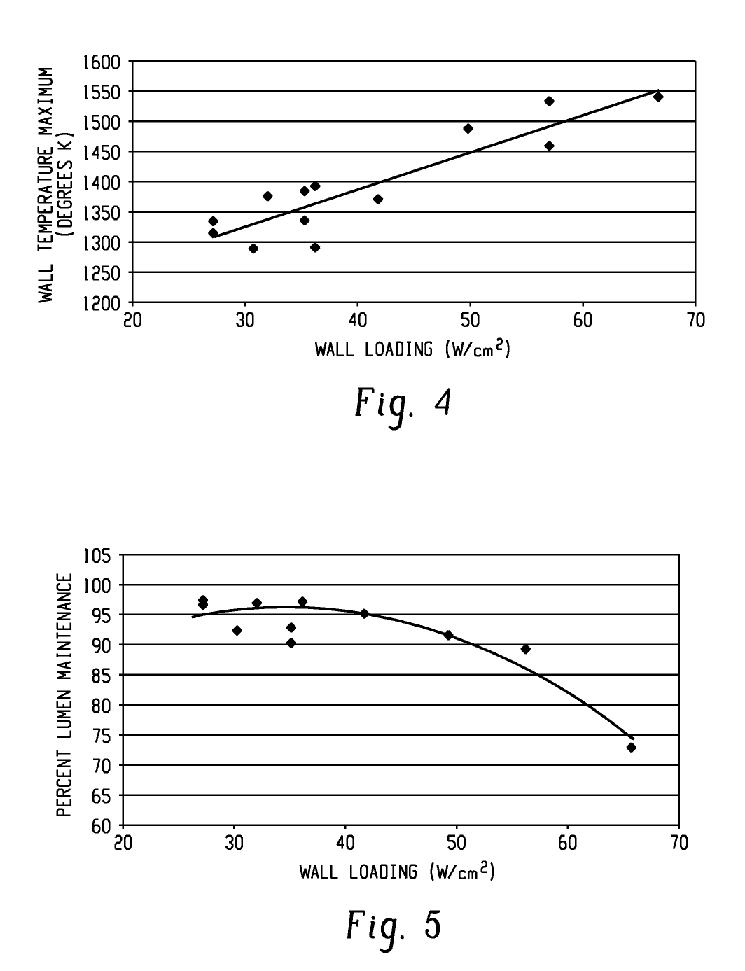

The exemplary lamp fill provides a lamp which can be run at relatively low wall loading while maintaining desirable lamp properties. As illustrated in FIG. 4, high wall temperatures are correlated with wall loading. High intensity discharge lamps that operate at very high wall temperatures (>1500K for CMH) often have significant issues with reliability, due to thermally generated stresses, polycrystalline alumina corrosion, seal failures, and the like. This is because the mechanical strength of ply crystalline alumina (PCA) degrades with temperature. The maintenance of visible light, or lumen maintenance, is governed by several factors. Some of these factors are the result of reaction of the halide species with the discharge vessel, thus depleting some of the light emitting species from the arc. Typically, during the operation of the lamp, the electrode material is transported to the wall, forming an opaque coating, thus blocking the light and resulting in significant decrease in lumen maintenance. As shown in FIG. 5, the higher the wall temperature, or wall loading, generally the poorer the lamp lumen maintenance.

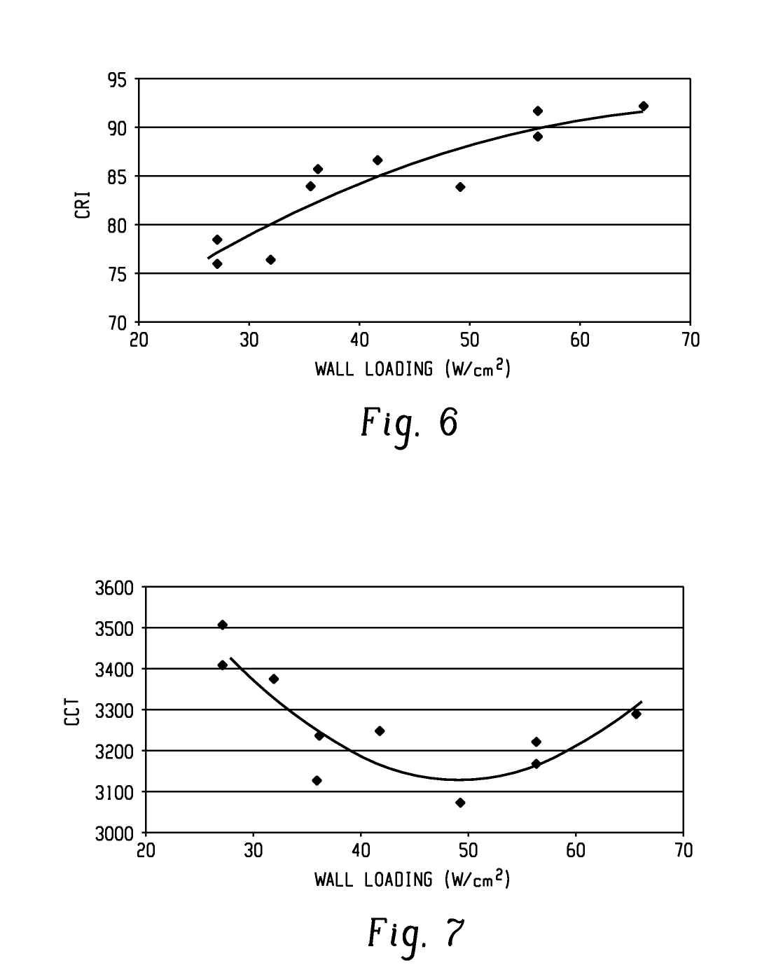

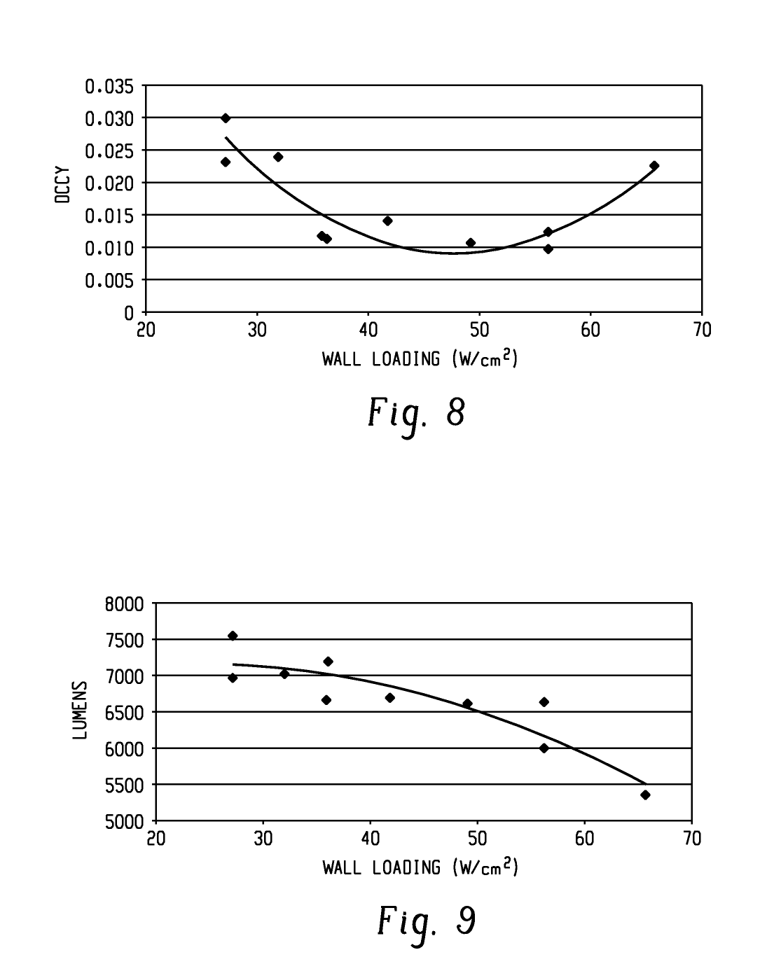

FIG. 6 illustrates the CRI of a typical CMH lamp, as function of wall loading. FIG. 7 illustrates CCT behavior of a typical CMH lamp with wall loading. FIG. 8 illustrates how DCCY behaves with wall loading. FIG. 9 describes how lamp lumens are affected by wall loading. With reference also to FIG. 5, it can be seen that in every case, if higher CRI, lower CCT and DCCY close to the black body locus are desired, lamp lumen maintenance generally has to be sacrificed. Similarly, the desirable values of CRI, CCT and DCCY correspond to higher wall temperatures (FIG. 4) and therefore result in lower reliability.

In the exemplary embodiment, a ceramic metal halide lamp is provided which is capable of more easily meeting all the technical requirements in terms of Dccy, CRI, CCT and Lumens, without impacting lamp reliability and lumen maintenance

The ceramic arctube may be formed from a single component or from multiple components. In a first embodiment, the arctube 12 is assembled from separate components. In the arctube of FIG. 3, there are three main components, the two end plugs 48, 50 and the cylindrical barrel portion 46, although fewer or greater numbers of components may be employed. The end plugs 48, 50 may be formed as single components (see FIG. 3) or may be separately assembled from the leg portions and base portions.

The components are fabricated, for example, by die pressing, injection molding, or extruding a mixture of a ceramic powder and a binder system into a solid body. For die pressing, a mixture of about 95-98% of a ceramic powder and about 2-5% of a binder system is pressed into a solid body. For injection molding, larger quantities of binder are used, typically 40-55% by volume of binder and 60-45% by volume ceramic material.

In one embodiment, the cylindrical portion body member 46 and the plug members 48, 50 can be constructed by die pressing a mixture of a ceramic powder and a binder into a solid cylinder. Typically, the mixture comprises 95-98% by weight ceramic powder and 2-5% by weight organic binder. The ceramic powder may comprise alumina (Al₂O₃) having a purity of at least 99.98% and a surface area of about 2-10 m²/g. The alumina powder may be doped with magnesia to inhibit grain growth, for example in an amount equal to 0.03%-0.2%, in one embodiment, 0.05%, by weight of the alumina. Other ceramic materials which may be used include non-reactive refractory oxides and oxynitrides such as yttrium oxide, lutetium oxide, and hafnium oxide and their solid solutions and compounds with alumina such as yttrium-aluminum-garnet and aluminum oxynitride. Binders which may be used individually or in combination include organic polymers such as polyols, polyvinyl alcohol, vinyl acetates, acrylates, cellulosics and polyesters.

An exemplary composition which can be used for die pressing a solid cylinder comprises 97% by weight alumina powder having a surface area of 7 m²/g, available from Baikowski International, Charlotte, N.C. as product number CR7. The alumina powder was doped with magnesia in the amount of 0.1% of the weight of the alumina. An exemplary binder includes 2.5% by weight polyvinyl alcohol and ½% by weight Carbowax 600, available from Interstate Chemical.

Subsequent to die pressing, the binder is removed from the green part, typically by thermal pyrolysis, to form a bisque-fired part. The thermal pyrolysis may be conducted, for example, by heating the green part in air from room temperature to a maximum temperature of about 900-1100° C. over 4-8 hours, then holding the maximum temperature for 1-5 hours, and then cooling the part. After thermal pyrolysis, the porosity of the bisque-fired part is typically about 40-50%.

The bisque-fired part is then machined. For example, a small bore may be drilled along the axis of the solid cylinder which provides the bore 60, 62 of the plug portion 48, 50 in FIG. 3. A larger diameter bore may be drilled along a portion of the axis of the plug portion to define the flange 84, 86. Finally, the outer portion of the originally solid cylinder may be machined away along part of the axis, for example with a lathe, to form the outer surface of the plug portion.

The machined parts are typically assembled prior to sintering to allow the sintering step to bond the parts together. According to an exemplary method of bonding, the densities of the bisque-fired parts used to form the cylindrical portion body member 46 and the plug members 48, 50 are selected to achieve different degrees of shrinkage during the sintering step. The different densities of the bisque-fired parts may be achieved by using ceramic powders having different surface areas. For example, the surface area of the ceramic powder used to form the body member 46 may be 6-10 m²/g, while the surface area of the ceramic powder used to form the end plug members 48, 50 may be 2-3 m²/g. The finer powder in the body member causes the bisque-fired cylindrical portion body member 46 to have a smaller density than the bisque-fired end plug members 48, 50 made from the coarser powder. The bisque-fired density of the cylindrical portion body member 46 is typically 42-44% of the theoretical density of alumina (3.986 g/cm³), and the bisque-fired density of the end plug members 48, 50 is typically 50-60% of the theoretical density of alumina. Because the bisque-fired body member 46 is less dense than the bisque-fired plug members 48, 50 the body member 46 shrinks to a greater degree (e.g., 3-10%) during sintering than the plug member 48, 50 to form a seal around the flange 84, 86. By assembling the three components 46, 48, 50 prior to sintering, the sintering step bonds the two components together to form a discharge chamber.

The sintering step may be carried out by heating the bisque-fired parts in hydrogen having a dew point of about 10-15° C. Typically, the temperature is increased from room temperature to about 1850-1880° C. in stages, then held at 1850-1880° C. for about 3-5 hours. Finally, the temperature is decreased to room temperature in a cool down period. The inclusion of magnesia in the ceramic powder typically inhibits the grain size from growing larger than 75 microns. The resulting ceramic material comprises a densely sintered polycrystalline alumina.

According to another method of bonding, a glass frit, e.g., comprising a refractory glass, can be placed between the body member 46 and the plug member 48, 50, which bonds the two components together upon heating. According to this method, the parts can be sintered independently prior to assembly.

The body member 46 and plug members 48, 50 typically each have a porosity of less than or equal to about 0.1%, preferably less than 0.01%, after sintering. Porosity is conventionally defined as the proportion of the total volume of an article which is occupied by voids. At a porosity of 0.1% or less, the alumina typically has a suitable optical transmittance or translucency. The transmittance or translucency can be defined as “total transmittance,” which is the transmitted luminous flux of a miniature incandescent lamp inside the discharge chamber divided by the transmitted luminous flux from the bare miniature incandescent lamp. At a porosity of 0.1% or less, the total transmittance is typically 95% or greater.

According to another exemplary method of construction, the component parts of the discharge chamber are formed by injection molding a mixture comprising about 45-60% by volume ceramic material and about 55-40% by volume binder. The ceramic material can comprise an alumina powder having a surface area of about 1.5 to about 10 m²/g, typically between 3-5 m²/g. According to one embodiment, the alumina powder has a purity of at least 99.98%. The alumina powder may be doped with magnesia to inhibit grain growth, for example, in an amount equal to 0.03%-0.2%, e.g., 0.05%, by weight of the alumina. The binder may comprise a wax mixture or a polymer mixture.

In the process of injection molding, the mixture of ceramic material and binder is heated to form a high viscosity mixture. The mixture is then injected into a suitably shaped mold and subsequently cooled to form a molded part.

Subsequent to injection molding, the binder is removed from the molded part, typically by thermal treatment, to form a debindered part. The thermal treatment may be conducted by heating the molded part in air or a controlled environment, e.g., vacuum, nitrogen, rare gas, to a maximum temperature, and then holding the maximum temperature. For example, the temperature may be slowly increased by about 2-3° C. per hour from room temperature to a temperature of 160° C. Next, the temperature is increased by about 100® C. per hour to a maximum temperature of 900-1100° C. Finally, the temperature is held at 900-100° C. for about 1-5 hours. The part is subsequently cooled. After the thermal treatment step, the porosity is about 40-50%.

The seals 96, 98 typically comprise a dysprosia-alumina-silica glass and can be formed by placing a glass frit in the shape of a ring around one of the leadwires 36, 38, aligning the arctube 12 vertically, and melting the frit. The melted glass then flows down into the leg 56, 58, forming a seal 96, 98 between the conductor and the leg. The arctube is then turned upside down to seal the other leg after being filled with the fill material.

Without intending to limit the exemplary embodiment, the following Examples demonstrate the performance of the exemplary lamp.

### EXAMPLES

### Example 1

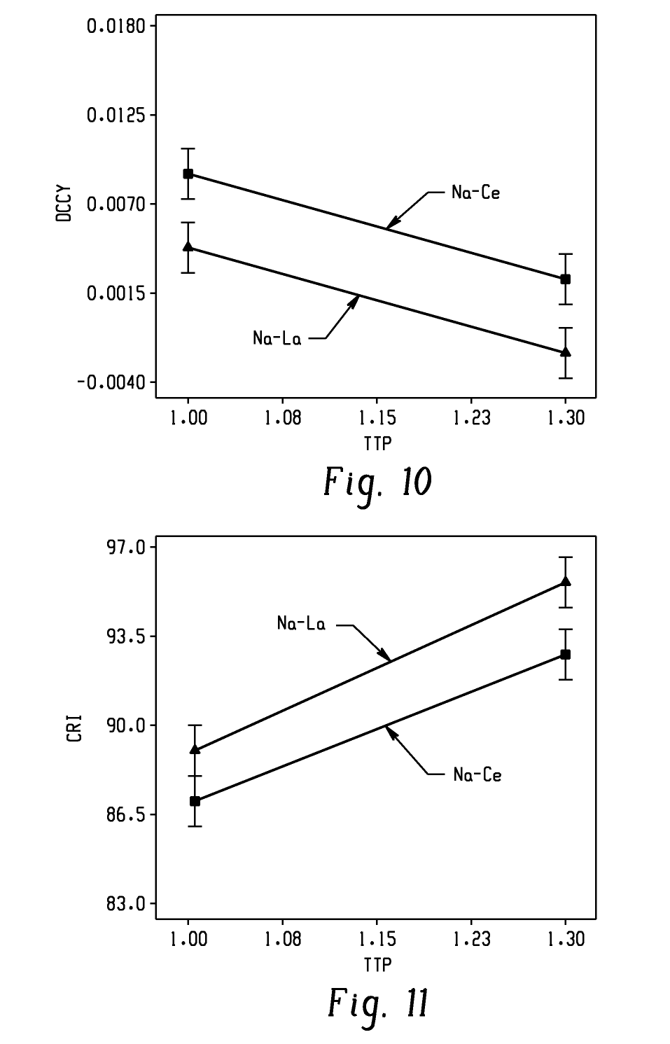

70 W hollow plug lamps according to the exemplary embodiment were formed with an arc gap of 5.6 mm, a barrel length L of 8.25 mm, a dose weight of 12 mg, and mole fractions of: NaI: 0.71, TII: 0.04, CaI₂: 0.18, and LaI₃: 0.07 (totaling 1.0) in a fill containing mercury (3.65 g) and argon gas at a fill pressure of 120 Torr. Such a lamp is referred in the following text and figures as “Na—La”, recognizing that the chemical fill for these lamps also includes CaI₂ and TlI. FIG. 10 shows plots illustrating the Dccy of such lamps, compared with that of otherwise identical lamps in which the lanthanum iodide is replaced with cerium iodide over a range of TTP from 1.00 to 1.30 mm. In the plot for the cerium-containing fill, the mole fraction of CeI₃ is 0.07, with other components being the same. Such a lamp is referred in the text and figures as “Na—Ce”, recognizing that the chemical fill for these lamps also includes CaI₂ and TlI.

It can be seen from FIG. 10 that the lanthanum iodide containing lamp (Na—La lamps) has a lower Dccy, for a given TTP, than the otherwise identical cerium iodide containing lamp (Na—Ce Lamp). This indicates the Na—La lamps have a spectral emission which is closer to the theoretical black body emission (0 on the Dccy scale) than the corresponding Na—Ce lamps and thus a lower tendency to have a greenish or reddish hue. At a TTP of about 1.3, the Na—La lamps have a Dccy which is very close to that of the black body curve.

With reference now to FIG. 11, plots of color rendition index (CRI) are shown for the lamps of FIG. 10. CRI is a measure of the ability of the light source 12 to reproduce the colors of various objects that are lit by the source, expressed on a scale of 0-100, where 100 generally represents the value for a black body radiator, according to the CIE method. As can be seen, for a given TTP, the Na—La lamps have a higher CRI, i.e., is closer to the theoretical maximum value, than the Na—Ce lamps.

With reference now to FIG. 11, plots showing the correlated color temperature (CCT) for the Na—La and Na—Ce lamps at 100 hrs are shown. It can be seen that the Na—La lamps have a lower CCT than the Na—Ce lamps at a given TTP. FIG. 13 illustrates the lumen maintenance of these lamps (as a percentage of lumens at 100 hours).

In the exemplary embodiment, the brightness of the La-lamp (in lumens) can be maintained in a range of 6072-7631 lumens by maintaining the TTP in the range of 1.0-1.3 mm and the barrel length L in the range of 8.05 to 8.45 mm.

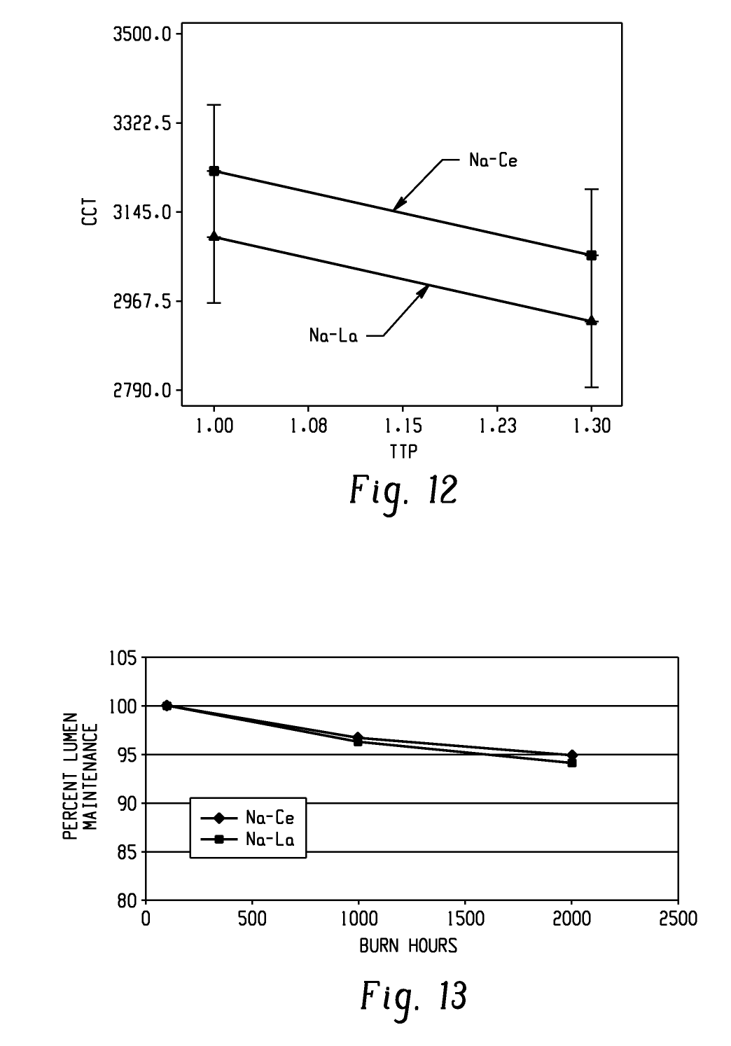

These results demonstrate that in order to achieve a desirable higher CRI, lower CCT, better Dccy, FIGS. 6, 7, and 8 show that this can be achieved for a Na—Ce lamp by increasing the wall loading, or providing correspondingly higher wall temperature. However, this will result in inferior reliability and poorer lumen maintenance (FIG. 5). The lumen maintenance data shown in FIG. 13 demonstrate that the Na—La lamps can achieve comparable lumen maintenance to the Na—Ce lamps while at the same time providing superior photometric performance, as shown in FIGS. 10, 11, and 12.

### Example 2

Table 2 provides a comparison of Na—Ce and Na—La lamps and a Na—La-lamp with a solid plug (no cavity). As discussed above, the use of lanthanum in the exemplary hollow plug lamp allows color targets in Dccy, CCT, Ra (and other measures such as R8, and R9) to be achieved more easily than for comparable Ce-lamps. Moreover, it can be seen that the hollow plug design is better for achieving the color targets than the solid plug design.

TABLE 2

| | Na—Ce | Na—La | Na—La |
|---|---|---|---|
| Design | Hollow Plug | Hollow plug | Solid Plug |
| D | 5.6 | 5.6 | 5.6 |
| L | 8.1 | 8.1 | 8.2 |
| tb | 1.34 | 1.34 | 1.34 |
| TTP | 1.3 | 1.3 | 0.85 |
| AG | 5.45 | 5.45 | 6.5 |

| | mean | std. dev. | mean | std. dev. | mean | std. dev. |
|---|---|---|---|---|---|---|
| Volts | 90 | 2 | 95 | 3 | 99 | 3 |
| Lumens | 6863 | 279 | 6394 | 137 | 6852 | 145 |
| ccx | 0.4256 | 0.0033 | 0.4334 | 0.0039 | 0.4313 | 0.0052 |
| ccy | 0.4048 | 0.0010 | 0.4028 | 0.0011 | 0.4071 | 0.0065 |
| CCT | 3206 | 62 | 3050 | 63 | 3122 | 95 |
| CRI | 88 | 1 | 91 | 1 | 84 | 2 |
| R8 (Ra) | 73 | 3 | 78 | 3 | 58 | 5 |
| Dccy | 0.005 | 0.0018 | −4E−05 | 0.0012 | 0.005 | 0.006 |
| PTE MPCD | 4.1 | | 4.5 | | 7.6 | |

### Example 3

In another study, targets for photometric values were established, as follows:

| | |
|---|---|
| Lumens | 6000 |
| CCT | 3000 ± 50 |
| CRI | ≧93 |
| Dccy | 0 ± 0.005 at the measured CCT |

Lamps were prepared using various rare earth halides. As shown in Table 2, cerium, neodymium, lanthanum, praseodymium, samarium and thulium halides in combination with equivalent mole fractions of Na, Tl, and Ca halides were used, i.e., the mole fractions of all the rare earth halides were identical and were as follows: Na:Tl:Ca Re:0.72:0.03:0.18:0.07, in mole fractions. The lamps were tested (10 lamps per chemistry) and the results are shown in Table 3.

TABLE 3

| | Impact on Targets | | |
|---|---|---|---|
| | Lumens | CCT | CRI |
| La—Na—Tl—Ca | 0 | −1 | 0.3 |
| Ce—Na—Tl—Ca | 2 | 5 | −1.1 |
| Nd—Na—Tl—Ca | −10 | 18 | 3.2 |
| Pr—Na—Tl—Ca | 0 | 15 | 2.2 |
| Sm—Na—Tl—Ca | −34 | −4 | 0.7 |
| Tm—Na—Tl—Ca | −5 | 5 | 2.3 |

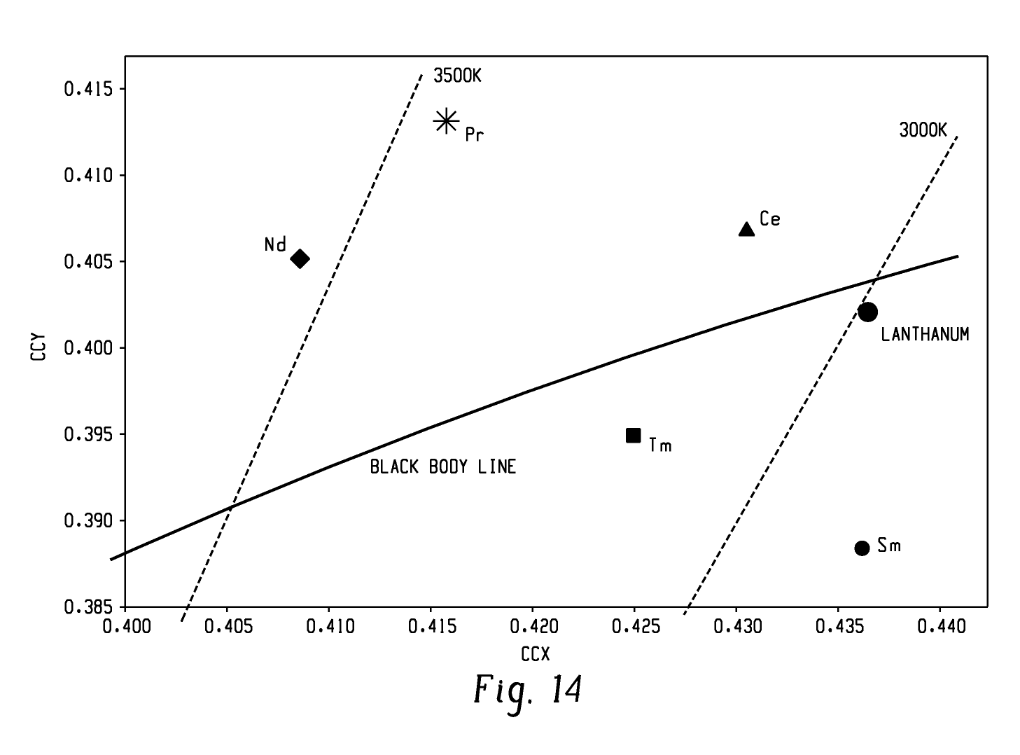

As can be seen from Table 3, only the lanthanum halide-containing lamp meets the CRI, CCT and Lumen target with ease. The Dccy plots of the various lamps described in Table 2 are shown in FIG. 14. The lanthanum containing cell is closest to the black body locus, at the 3000K target iso-CCT line. All other rare earth containing species, other than lanthanum, show some deficiency from the targeted photometric values. The lanthanum rare earth species shows greater facility and ease to obtain the desired photometric targets.

While it is to be appreciated that values closer to desired photometric targets could, perhaps, be achieved for the non-lanthanum containing lamps by increasing wall loading, the selection of higher wall loading, as previously discussed, is expected to compromise reliability and lumen maintenance. The exemplary lamps allow the targets to be satisfied without the need for compromising reliability and lumen maintenance.

### Example 4

In another experiment, the mole fraction of lanthanum halide in lamps otherwise similar to those of Example 1 was varied at 3 levels (0.04, 0.07, and 0.1 mol fraction). All lamps performed well, as shown in TABLE 4. However, the results indicated that the lamps with the 0.07 mol fraction most closely matched the targets. As will be appreciated, if somewhat different targets, or if a higher CRI is desired and other targets are less important, the lamps with a mole fraction of 0.04 or 0.1 La would allow this to be achieved.

TABLE 4

| | Mol. Fraction La | | |
|---|---|---|---|
| | 0.04 | 0.07 | 0.1 |
| | Deviation from Target Values | | |
| Lumens | 90 | 0 | −90 |
| CRI | −1.5 | 0 | 1.5 |
| CCT | −120 | 0 | 120 |
| Dccy | −0.003 | 0 | 0.003 |

The invention has been described with reference to the preferred embodiments. Obviously, modifications and alterations will occur to others upon reading and understanding the preceding detailed description. It is intended that the invention be construed as including all such modifications and alterations.

What is claimed is:

1. A lamp comprising:
a discharge vessel;
electrodes extending into the discharge vessel;
an ionizable fill sealed within the vessel, the fill comprising:
a buffer gas,
optionally mercury,
a halide component comprising a sodium halide, a lanthanum halide, a thallium halide, and a calcium halide.

2. The lamp of claim 1, wherein the sodium halide is present in the halide component at a mol fraction of at least 0.5.

3. The lamp of claim 2, wherein the sodium halide is present in the halide component at a mol fraction of 0.6-0.8.

4. The lamp of claim 1, wherein the lanthanum halide is present in the halide component at a mol fraction of at least 0.04.

5. The lamp of claim 4, wherein the lanthanum halide is present in the halide component at a mol fraction of 0.05-0.1.

6. The lamp of claim 1, wherein the thallium halide is present in the halide component at a mol fraction of 0.03-0.6.

7. The lamp of claim 6, wherein the calcium halide is present in the halide component at a mol fraction of at least 0.09.

8. The lamp of claim 1, wherein the mole fractions of the dose components are in the relationship NaI:TlI:CaI₂:LaI₃=0.71:0.04:0.18:0.07, where each value can vary by no more than ±5% of its value.

9. The lamp of claim 1, wherein the fill is free of all rare earth halides other than halides of lanthanum.

10. The lamp of claim 1, wherein the lamp simultaneously satisfies the following targets:
a wall loading of less than 35 w/cm²;
a Dccy of +/−0.005;
a correlated color temperature (CCT) between about 2800 K and about 3200 K;
a CRI of at least 90; and
a lumen output at 100 hours of at least 90 LPW.

11. The lamp of claim 10, wherein the lamp further satisfies a lumen maintenance of at least 95% at 2000 hours, at wall temperature which is no greater than 1360 K.

12. The lamp of claim 1, wherein the discharge vessel includes a generally cylindrical wall sealed at either end by a hollow plug which carries an electrode therethrough.

13. The lamp of claim 12, wherein the plug defines a cavity with an interior depth which is at least equal to a thickness of the thinnest portion of an end wall of the plug.

14. The lamp of claim 1, wherein the lamp vessel includes a generally cylindrical wall sealed at either end by a plug which carries an electrode therethrough, the plug having an end wall with a minimum thickness which is greater than 0.6 mm.

15. The lamp of claim 1, wherein the fill includes mercury.

16. The lamp of claim 1, comprising a geometry whereby:
a wall thickness (tb) is from 1-2 mm;
a plug thickness (tp) is from 0.5-2 mm:
an inner length (L) is from 6-10 mm;
an inner diameter (D) is from 5-7 mm;
an arc gap (AG) is from 3-8 mm;
a tip-to-plug distance (TTP) is from 0.9-3.3 mm; and
wall loading (WL) is from 27-34 w/cm².

17. A method of forming a lamp comprising:
providing a discharge vessel;
providing electrodes which extend into the discharge vessel;
sealing an ionizable fill within the vessel, the fill comprising:
a buffer gas,
optionally mercury, and
a halide component comprising a sodium halide, a lanthanum halide, a thallium halide, and a calcium halide.

18. A method of operating a lamp comprising:
providing the lamp of claim 1;
operating the lamp by supplying an electric current to the lamp to generate a discharge in the lamp vessel, wherein in operation, the lamp operates at:
a wall loading of less than 35 w/cm²;
a Dccy of +/−0.005;
a correlated color temperature (CCT) between about 2800 K and about 3200 K;
a CRI of at least 90; and
a lumen output at 100 hours of at least 90 LPW.

19. A lamp comprising:
a discharge vessel;
electrodes extending into the discharge vessel;
an ionizable fill sealed within the vessel, the fill comprising:
a buffer gas,
optionally mercury,
a halide component consisting essentially of a sodium halide, a lanthanum halide, a thallium halide, and a calcium halide.

20. The lamp of claim 19, wherein the lamp further satisfies a lumen maintenance of at least 95% at 2000 hours, at wall temperature which is no greater than 1360 K.
